(19) United States
(12) Patent Application Publication
(10) Pub. No.: US 2008/0134912 A1
(43) Pub. Date: Jun. 12, 2008

(54) Method and Apparatus For Providing Embossed Hidden Images

(75) Inventor: Ron Golan, Tel Aviv (IL)

Correspondence Address: PAUL, HASTINGS, JANOFSKY & WALKER LLP, 875 15th Street, NW, Washington, DC, 20005, US

(73) Assignee: STAR-BOARD TECHNOLOGIES LTD., Caesarea (IL)

(21) Appl. No.: 10/555,071

(22) PCT Filed: Apr. 28, 2004
(86) PCT No.: PCT/IL2004/000354

§ 371 Date: Nov. 12, 2007

(30) Foreign Application Priority Data
Apr. 29, 2003 (IL) 155659

(51) Int. Cl. H01B 7/36; B42D 15/00

(52) U.S. Cl. 101/32; 283/85

(57) ABSTRACT

A method for providing a hidden image within a substrate the method comprising embossing recesses on the substrate, the recesses form an at least one hidden image, whereby the at least one hidden image can be viewed with the use of at least one decoder. The decoder can be embossed in a similar manner.

### BACKGROUND OF THE INVENTION

1. Field of the Invention

The present invention relates to a method and apparatus for providing hidden images, in general, and to a method and apparatus for providing embossed hidden images within substrates, in particular.

2. Discussion of the Related Art

Many billions of U.S. Dollars are lost annually as a result of counterfeiting of valuable papers such as bank papers notes, bank checks, formal documents and the like. Additionally, great financial loses result from counterfeiting and forging of brand labels, licenses and the like. Subject to the dramatic development of copying machines, scanners the path for dishonest behavior by scanning, copying and duplication of highly resembled to originals of printed matter is becoming convenient and prevalent. Consequently, there is an extensive requirement for counter measurements to prevent counterfeiting of documents as well as other printed matter and products. One leading measure for counterfeiting detection is achieved by using hidden images. Hidden images, also known as concealed images or icons, can also be used in the fields of marketing and promoting goods and services. In addition, the authenticity of documents is of great import in the conduction of commercial transaction.

The term “hidden image” is generally used in the printing industry to describe a hidden pattern printed on paper. The hidden image is composed of printed ink dots and lines that are printed in a manner that is normally impossible to be viewed by a naked eye. Hidden images are broadly used as providing anti counterfeiting measure of printed matter. Some examples include bank notes, bank checks, tickets, famous brand labels, and the like. Though hidden images are broadly used for providing anti counterfeiting measure of printed matter they may be used for amusement activities, marketing, licensing, promotional activity, merchandising ads well as consumer protection, as well as for other uses. The major advantage for using hidden images as anti counterfeiting measure are within the simplicity to detect forgery performed by using a usually accessible apparatus or other aid, depending on the hidden image's type, that reveals the hidden image to the eye. According to one type of hidden image that requires an optical decoder it is sufficient to place the decoder on the printed matter's surface for enabling a person to view the presence or absence of a hidden image and consequently verifying whether the printed matter is genuine.

Methods of creating hidden images such as Moiré inducing patterns, fluorescent inks, micro printing images and the like are known in the art. U.S. Pat. No. 5,708,717 by Alasia discloses a method of printing hidden images aided with computer software through the use of printers or other printing device. Alasia does not contemplate other methods of creating hidden images.

Currently known hidden images printing techniques exploit the inability of the human naked eye to view below a particular resolution. Accordingly, hidden images are printed below the resolution a human eye is able to comprehend. Nevertheless, hidden images are provided with apparatuses that enable to view the hidden images such as optic decoders, suitable illumination, magnification lenses and the like.

Another factor diminishing the extent of use of hidden images as an anti counterfeiting measure is due to reproduction ability of hidden images created through the process of print. Hidden images created through the process of printing can be revealed by changing the resolution and enlarging the printed matter wherein the hidden image exists. Once the hidden image is detected it can be scanned reproduced and printed within a counterfeited or non-original printed matter.

There is therefore a need to provide a method and an apparatus that will enable the use of hidden images in a manner that will not be limited to the type nor to the coloring of the printed matter it is inserted into. There is therefore a further need to provide a method to insert hidden images in a manner that will be difficult to duplicate. The invention disclosed below provides a solution for the long felt need indicated above and provides a method for inserting hidden images on a great variety of substrates for preventing reproduction of printed matters as well as for other purposes.

### SUMMARY OF THE PRESENT INVENTION

In accordance with one aspect of the present invention, there is provided a method for providing a hidden image within a substrate the method comprising the following steps:

providing an image to be converted into the digital information to be used for engraving protrusions/recesses onto an embossing platform member;

converting the image provided into digital information comprising the locations on an embossing platform member for creating protrusions, the conversion comprises selecting the features of the image located along predetermined lines or wave like lines representing the optical frequency to be used in the creation of the hidden image or the reverse optical frequency to be used in the creation of a decoder;

determining from the digital information the location of each recess to be engraved unto an embossing platform member representing the hidden image to be embossed on the substrate;

engraving protrusions associated with digital information representing the hidden image onto an embossing platform member;

Embossing recesses on the substrate, the recesses form a hidden image, whereby the hidden image can be viewed with the use of at least one decoder.

The recesses can be embossed on both sides of the substrate. The step of embossing can comprise an embossing platform member applying pressure on the substrate for creating the recesses thus forming the at least one hidden image. The hidden image can comprise text or at least one animated figure or a combination thereof. Also disclosed is a decoder that is made of a flexible material embossed with an at least one set of lines for revealing the hidden image formed by the recesses on the substrate.

The substrate is a material having sufficient flexibility to be used in the process of embossing. The substrate used can be any one of the following substrates: polymeric sheet, fabric, processed wood, metal sheet, or a composition of thereof. The recesses can be about 1-50 microns in depth. The recesses can be about 1-30 microns in diameter. The hidden image can be used for determining whether the substrate is original or approved or for revealing a message or an image, or for determining the substrate's authenticity. A decoder may be attached to the substrate. The embossing platform member can comprise a steel or metal core having a thin plated layer of copper and coated with chrome. The embossing platform member can be in the form of a cylinder or a sleeve to be put on the cylinder or a plate. The step of engraving can comprise engraving on the surface of the embossing platform member of a mirror hidden image to be embossed on the substrate (Flat embossing member). The step of engraving comprises providing protrusions unto the embossing platform member. The protrusions represent a mirror image of the optical frequency used in to emboss the at least one hidden image. The number of lines to be used in encoding of the at least one hidden image is about 1,000 lines per inch.

In accordance with a second aspect of the present invention, there is provided a substrate comprising an embossed hidden image, the hidden image is embossed onto a substrate, the hidden image is created in association with an optical frequency not visible to the naked eye, the hidden image cannot be seen without the use of a decoder having a reverse optical frequency. The substrate can be made of a polymer or metal or wood or leather or a composite material or like material. The embossed hidden image comprises recesses in a depth of about 1-50 Microns or a diameter of about 1-30 Microns at the upper surface of substrate. The hidden image can comprise text or at least one animated figure or a combination thereof or any other indicia. The substrate can be any one of the following substrates: polymer, fabric, wood, metal, or a composition thereof or like substrates. The hidden image can be used for determining whether the substrate is original or approved, or for revealing a message or an image, or the substrate's authenticity.

A third aspect of the present invention regards a substrate comprising a decoder for viewing an embossed hidden image, the decoder comprises embossed or printed lines having a similar optical frequency to the optical frequency used to create the hidden image embossed onto a substrate. The decoder can be made of a polymer or a clear material allowing the placement of the decoder upon the substrate containing the hidden image so that when the decoder is placed in a predetermined angle the hidden image is revealed through the decoder. The decoder may be attached to a substrate including a hidden image

### BRIEF DESCRIPTION OF THE DRAWINGS

The present invention will be understood and appreciated more fully from the following detailed description taken in conjunction with the drawings in which:

FIGS. 1A, 1B, 1C illustrate an image and the insertion of the image within a printed matter creating a hidden image known in the art;

FIG. 2A illustrates an image to be embossed within a substrate in accordance to one preferred embodiment of the present invention;

FIG. 2B illustrates a perspective overview of a substrate including a hidden image in accordance to one preferred embodiment of the present invention;

FIG. 2C illustrates a side view of the recesses creating a hidden image and substrate according to one preferred embodiment of the present invention;

FIG. 2D illustrates a perspective overview of a substrate including a hidden image in accordance to one preferred embodiment of the present invention;

FIG. 3 is a flowchart of the implementation of the method and apparatus in accordance of one embodiment of the present invention;

FIGS. 4A and 4B illustrate an overview perspectives of the apparatus used in accordance to one preferred embodiment of the present invention;

FIGS. 4C, 4D and 4E illustrate protrusions used to realize preferred embodiments of the present invention;

FIG. 5 illustrates an apparatus and method used to provide hidden images in accordance to one preferred embodiment of the present invention;

FIG. 6 illustrates an apparatus and method used to provide hidden images in accordance to a second preferred embodiment of the present invention;

FIG. 7 illustrates an apparatus and method used to provide hidden images in accordance to a third preferred embodiment of the present invention;

FIG. 8 illustrates an apparatus and method used to provide hidden images in accordance to a fourth preferred embodiment of the present invention.

### DETAILED DESCRIPTION OF THE PREFERRED EMBODIMENT

The present invention discloses a method for providing hidden images on substrates by creating recesses or protrusions on substrates. Hidden images are also known as concealed images or icons. The hidden image can be embossed on a substrate and can be viewed with a suitable decoder. Thus, the embossed image substrate according to the preferred embodiment can be provided with any shade, hue or other printed pattern on the surface of the substrate. Furthermore, the method of embossing hidden images disclosed by the present invention provides a difficult measure for counterfeiting elements. The method and apparatus disclosed by the present invention can be used for security-based applications, such as to prevent counterfeiting or copying, as well as for promotional purposes and merchandising. It can also be used for entertainment purposes and to secure the authenticity of a product or service provided. A suitable decoder made of a clear simple polymer or laminate, such as plastic, or PVC sheet can be provided for each embossed hidden image created. The method and apparatuses presented within the invention will be provided in view of the Figs below.

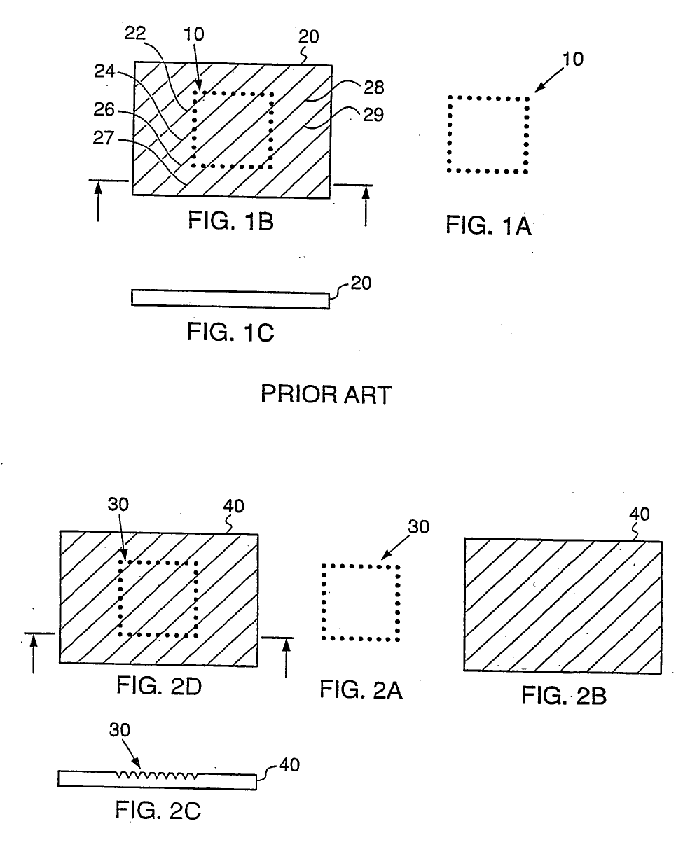

FIG. 1A illustrate an image and the insertion of the image within a printed matter creating a hidden image known in the art image 10 comprising ink dots and refers to printed hidden images only. The image 10 may comprise an image or letters or a phrase or other like indicia, which can later be identified as the mark of the hidden image. The image 10 can be printed in various colors. The image 10 may provide such words as “ORIGINAL” or an image or a combination thereof or like indication upon which it was printed. FIG. 1B shows printed matter 20 and a hidden image 10 within. Printed matter 20 can be any matter upon which ink can be printed. As will be described below some crucial limitations apply to the printed matter 20 which may used in association with currently available hidden images 10. Hidden image 10 printed on printed matter 20 is printed along lines 22, 24, 26, 27, 28, 29 of the printed matter 20 having fixed distance intervals between the dots comprising hidden image 10. While the lines shown in FIGS. 1B, 2B, 2D are straight, other lines such as lines in a wave form keeping a predetermined distance intervals may be used. The use of wave like lines may allow additional frequency combinations to be used for creating the hidden images. The printing of hidden image 10 along lines 22, 24, 26, 27, 28, 29 is accomplished by placing ink along the points corresponding with the hidden image 10 and the lines 22, 24, 26, 27, 28, 29. This means that ink is not placed in between the lines. Thus, a particular optic frequency between all hidden image 10 dots is created. The optic frequency is created through the use of fixed distance applied between the lines 22, 24, 26, 27, 28, 29. The printing of the hidden image 10 along the lines limits the ability of the unaided human eye to identify the hidden image. Thus, a suitable specific decoder matching the optical frequency created may be supplied as an aid to view hidden image 10 in a clear manner. For the purpose of demonstration of the prior art only, the dots comprising image 10 within printed matter 20 are proportionally much thicker than the normal proportion between hidden image dots and printed matter lines of printed matter. There are a number of crucial factors that impose the nature of the dots and lines that are used to comprise the hidden image within any particular printed matter. Uniform background (original image) should be a normal screened half-tone image. Factors such as the darkness of colors used within the printed matter, the versatility of the colors within the printed matter and other factors. Such factors are dictated by the printed matter wherein the hidden image to be printed. Accordingly, uniform color and dark complexion colors within a printed matter provide a barrier for having a hidden image such as shown in FIG. 1B. In such cases, the uniform background will prevent users from seeing the hidden image 10 despite of the use of decoders. Additionally, when dark complexion colors are used within a printed matter the dots used for the hidden image are required to be thicker and more visible. Thus, dark color used within the printed matter requires the image to be less hidden and requires often to change colors complexion to a lighter hue and necessitate a not uniform coloring for the printed matter. Said factors as well as other requirements present difficult burden for designers, for known brands owners, as well as for others that wish to use hidden images as anti counterfeiting measure. One example for said difficulty is within well-known brands having uniform dark printed matter. Said well-known brands owners that wish to use hidden images as anti counterfeiting measure are compelled to change their well known brand. Consequently, changing a well-known brand enjoying a meaningful reputation and goodwill means loss of considerable funds.

FIG. 1C shows a side view of printed matter 20 upon which hidden image 10 is printed. As can be clearly seen from FIG. 1C the printed matter 20 substrate is flat and does include any depressions or recesses. The printed hidden image 10 is best seen when the printed matter 20 is flat enabling a horizontal surface upon which the decoder can be placed.

FIG. 2A shows an image to be embossed within a substrate in accordance to one preferred embodiment of the present invention. Image 30 presented in FIG. 2A according to the preferred embodiment of the present invention can be any kind of image shape and from any size and is not limited to image 30 shown. Additionally, image 30 can be an image such as a letter or a group of letters and sentences at any length of form and can have a statement such as “REAL”, “Authentic” or “This Product is Real”, “ORIGINAL”, “APPROVED”, “AUTHENTIC”, “<NAME OF MANUFACTURER>”, “<NAME OF PRODUCT>”, “<DATE OF MANUFACTURE>”, “<EXPIRATION DATE>”, “<BATCH NUMBER>”, “<PRIZE WON>”, and other. Image 30 may comprise an animated figure or any other image or data which may be used to convey a message to the person inspecting the product with a decoder. Image 30 may comprise a combination of words and animated figures. Image 30 may comprise two images or more each embossed using a different frequency thus allowing two different images 30 to be viewed by two different decoders or one decoder having two corresponding frequencies embedded thereupon in different angles. When such a decoder is placed on the multiple images embossed it will reveal one image when placed on the substrate in a predetermined angle and another image when placed on the substrate in the alternate angle.

FIG. 2B shows a perspective overview of a substrate including a hidden image in accordance to one preferred embodiment of the present invention. Image 30 is embossed within substrate 40 and cannot be seen by the naked eye. The lines shown on FIG. 2B are for demonstration purposes. Such lines are shown in FIG. 2B for comparison with lines 22, 24, 26, 27, 28, 29 of FIG. 1B. As noted above the lines may be formed in a wave like shape to increase the number of possibilities used to create the hidden image. Substrate 40 according to one embodiment is aluminum foil that can have famous brand tag such as Johnny Walker Black Label already printed thereon. In one example, a label for a bottle of liquor made of aluminum foil can be produced by the liquor manufacturer with the manufacturer's label on one side or on both sides. Next, a hidden image may be embossed onto the label, in accordance with the present invention. Later, the label can be attached to the liquor bottle. The image 30 is not printed and no ink is placed on the label in addition to the ink used for the preparation of the label. It will be evident to those skilled in the art that many other substrates are contemplated to be used in association with the present invention. Such can include plastic and other polymers, paper, cellophane, leather, fabric, wood, metals, and the like. Unlike the parallel example shown in FIGS. 1A and 1B, image 30 is not a part of the printed matter placed on the substrate 40 and no ink is used to create the hidden image. In addition, by the embossing process creating image 30 the said image is present at a different surface level than the print comprising the ink placed on the substrate 40.

FIG. 2C shows a side view of the recesses creating a hidden image and substrate according to one preferred embodiment of the present invention. As can be viewed in FIG. 2C image 30 is embossed within substrate 40. The size of the recesses within substrate 40 comprising image 30 according to the preferred embodiment is about 15 micro centimeters (Microns) depth and about 5 Microns diameter at, surface of printed matter 40. Other recesses sizes can be used to emboss the hidden image 30 onto the substrate 40. The present invention should not be limited by technology present at the time of the invention, rather it is contemplated that with the passage of time smaller recesses can be used thus increasing the resolution of the embossed hidden image while decreasing the size of the recesses used. In addition, the smaller the recesses can be achieved the thinner the substrate 40 can be. For example, very thin cellophane can be used even without background print as a suitable substrate for the embossed hidden image 30. One such cellophane can be used to wrap a product whereby the wrap itself will indicate the authenticity of the product itself. This enables a wide variety of products to be used in association with a single manufactured wrap. In addition, the embossed hidden image contemplated by the present invention can be embossed directly on containers and substrates that are not currently used for verifying authenticity of products or for using the hidden image for other purposes. Such can include embossing the hidden image directly on a product such as a belt or perfume bottle, or a can of drink, a box of cigarettes, music or software CD or other media and the like. Such uses may be for promotional purposes, security based applications, amusement and entertainment applications, merchandising and the like. One additional example will include the embossing of the hidden image onto an employee's tag whereby the authenticity of the tag can be verified by the use of a suitable decoder. Two different images can be used on one side of the tag or on either side of the tag enabling different levels of security and authentication. In yet another example, the hidden image can embossed on the aluminum foil or other wrap of a drug marketed to consumers thus providing the ability to the consumers to verify that the drug originates from the true drug manufacturer. Another non-limiting example is the embossing of the hidden-image on a product during a campaign to promote such product whereby the product bearing a specific hidden image may win a prize. Such products may be marketed directly with a decoder to enable the consumers upon the opening of the package to reveal the hidden image. To market such a product with a decoder, the decoder may be attached to the substrate into which the hidden image is embossed. The attaching of the decoder can be through the manufacturing of the decoder together with the embossed hidden image or later attaching the decoder can be used for security purposes and placed on substrates such wood, paper, metals and the like. To name but a few examples, the hidden image can be embossed directly on passports, security cards, keys, doors, contracts, seals, locks and the like.

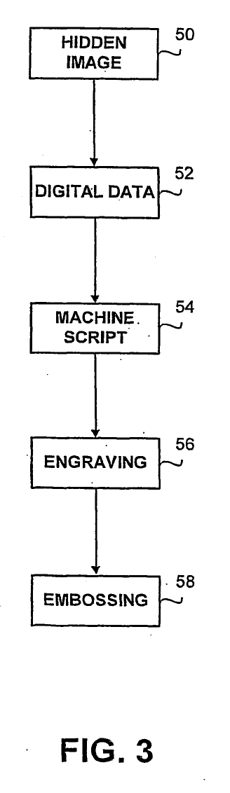

FIG. 2D shows a perspective overview of a substrate including a hidden image in accordance to one preferred embodiment of the present invention. According to the preferred embodiment of the present invention a dual measure for detection of the hidden image is provided. The hidden image 30 is embossed onto the substrate 40 through the use of an algorithm according to which the hidden image 30 is embossed across lines which create an optical frequency which is not visible to the naked eye. Embossing the hidden image along various prearranged lines will enable different optical frequencies to be used. Corresponding visual decoders can be used to view the hidden image as embossed on the substrate 40. While FIG. 2D shows diagonal lines, such lines are not present on the substrate but are used in conjunction with a computer software for determining the distance and angle between each embossed impression on the substrate. Thus, a particular location in hidden image, which do not correspond with the predefined line, will not be embossed. The lines shown are exemplary. Various other configurations of the lines, such as horizontal or vertical as well as in various angels and forms can also be used to obtain the corresponding optical frequency. Computer programs which allow the determination of the correct locations for placing recesses are available and can be used to calculate the desired optical frequency which will enable the embossing of a hidden image onto the substrate whereby the hidden image will not be visible to naked eye, but can be visible if a decoder is used. Such decoders can be made of a transparent flexible or rigid material such as plastic, PVC, laminate and the like. The decoder will include corresponding distortions, through the use of ingressions or coloration, which will enable the decoding of the optical frequency used resulting in the revealing of the hidden image. As noted above, the substrate according to other embodiments of the present invention can be paper of different thickness and quality, plastic and other polymer material, leather material, leather resembling materials, metals as well as other substrates. According to other embodiments of the present invention the recesses and protrusions within different substrates upon which the hidden image is embossed can vary between about 1-50 Microns depth beneath upper surface and between about 1-30 Microns diameter of recess at the upper surface of substrate. The preferred depth beneath the upper surface is about 10-20 Microns. The number of lines to be used in association with the encoding of the hidden image can reach about 1,000 per inch. Persons skilled in the art will appreciate that other combinations of the lines per inch as well as the depth and diameter of the recess can be used and that such combination may be determined according to the substrate embossed with the hidden image as well as the embossing apparatus used. A fundamental understanding of the method and apparatus used to form hidden images according to the present invention will be shown in view of FIG. 3.

FIG. 3 presents a flowchart of the steps that can be taken to provide a hidden image according to one embodiment of the present invention. In step 50 a hidden image to be embossed is loaded. The hidden image is drawn with a graphical software program and saved as a graphical software file such as a Tiff (Tagged Image File Format) file using the Photoshop computer program by Adobe, San Jose. The Tiff file is a known standardized format produced by the Microsoft Corporation for organizing pixel based image data. Other formats such as EPS (encapsulated Post Script) or vectoric illustrator files may be used alternatively to achieve 64 or 128 bit resolution. Next in step 52 the graphical hidden image data file from previous step 50 is converted to digital data format. According to the digital data conversion step 52 the hidden image data is converted from the Tiff r like file to a digital readable data format such that each contour of the image is rendered into the production file only if it corresponds to lines 22,24,26,27,28, 29 or such lines associated with the frequency of the hidden image to be embossed. In step 54 a machine script data is prepared from the digital data file created in step 52. Steps 52 and 54 are optional and can be performed by CYNOTYPE Interface software program manufactured by HelioCom manufactured by HelioKlischograph, Germany. The process of preparing the hidden image file to be engraved is associated with the frequency of the decoder to be used to reveal the hidden image to be embossed. In step 56 the hidden image is engraved onto a steel or metal core having a thin plated layer of copper and an additional layer of chrome on top into which the engraving of the hidden image is performed. The chrome layer is only several Microns thick and is designed to fix the information engraved on the cylinder or platform. Engraving can be accomplished using various methods such as by computer aided laser engraving directly onto the cylinder or plate used for the embossing step. Other methods, which can be used, include placing an engraved cylinder or plate in an acid emulsion, or through the use of a specifically designed diamond head or by a milling process through which the plate or cylinder is milled or cut later to be used for the embossing step. The engraving is performed along the lines shown in association with FIG. 2D or along similar lines determined by the operator which will enable the embossing of the hidden image onto a substrate and from which the hidden image cannot be seen by the naked eye or without an appropriate decoder. One engraving machine, also known as a gravure, can be the HelioKlischograph K500 manufactured by HELL Gravure Systems from Kiel, Germany. The K500 and like gravures can be used in some preferred embodiments of the present invention.

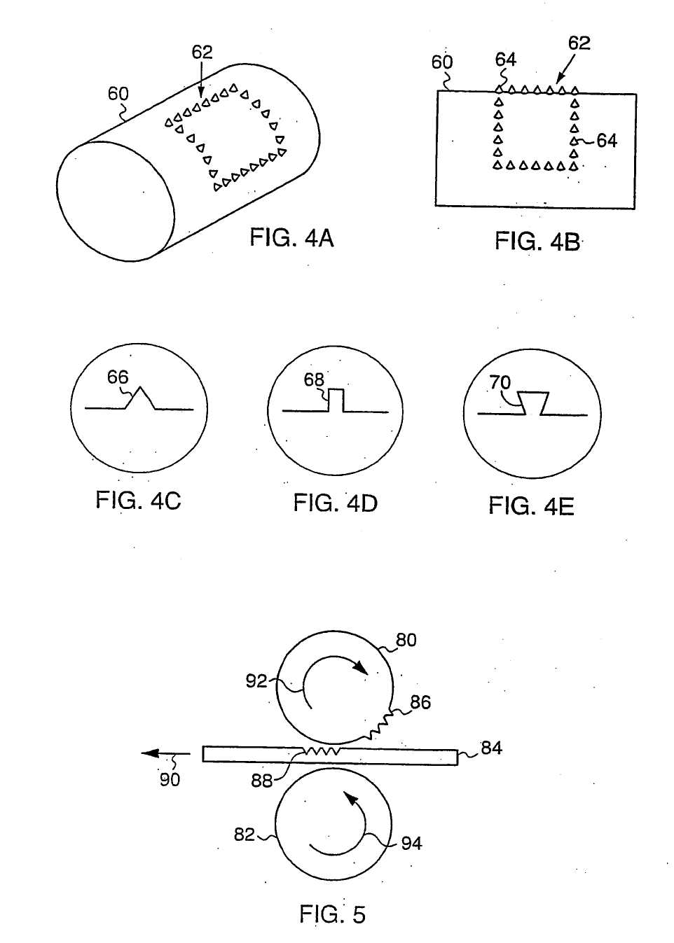

The engraving step 56 according to the preferred embodiment includes the engraving of the mirror-hidden image to be embossed on substrate on a suitable platform. Thus, engraving on said platform and providing desired protrusions enable the embossing of hidden images engraved on a substrate according to the invention. The platform to be engraved can be a cylinder roller member such as shown in FIGS. 4A and 4B. Thus, the engraving of cylinder roller member that is having its upper surface from a special durable external surface such as stainless steel with a thin layer of copper. The engraved platform can be in the size for a few Microns, preferably about 15 Microns, but suitably anywhere from 1-30 Microns depending on the ability of the engraving method used and the type of embossed substrate and depending on whether the engraving process uses heat or not. As noted above, according to the preferred embodiment the engraving step 56 is performed by high-energy laser beam that emerges from an engraving machine. Such laser beam is able to create protrusions with the precision of a number of microns. The laser beam engraves and creates protrusions on the cylinder roller member. According to other embodiments the external durable surface of cylinder roller member is a sleeve that is pulled on an embossing machine. In accordance with this alternative cylinder roller the step of engraving 56 is performed on the said sleeve that is later upon completion of engraving is pulled on cylinder roller member of an embossing machine. Engraving patterns on cylinder roller members is currently being used for production of cylinder roller members used within the leather resembling materials as well as within other mass production of refined tissue paper cigarette packs and wall tapestry and the like. Other methods for engraving within the engraving step 56 can be electro mechanical or magnetic control of a diamond-head or other durable and rigid head that is controlled and activated by a machine and assisted by a computer. One example of a computer controlled electromechanical engraving machine is HelioKlischograph K500 manufactured by HELL Gravure Systems from Kiel, Germany. The engraving step 56 can be performed by a combination of laser exposure and chemical aided engraving. Alternatively the engraving can be performed through other known methods used for creating a template for embossing or other methods known for engraving on a cylinder later to be used for embossing. The engraving step 56 according to other embodiments can be performed on flat durable surface such as shown in FIGS. 7 and 8. The engraving step 56 according to the present invention requires fine capability for creating small and exact dimensions of protrusions on the embossing plate member. The exact size and dimensions of the protrusions are set according to the embossed substrate. Thus, substrates that contain an elastic ability will require cylinder roller or flat embossing plate member containing longer and wider protrusions than substrates that do not contain such elastic capability. The preferred but not limiting length of the protrusions would preferably be about 1-50 Microns.

The final step according to the preferred embodiment of the present invention is the step of embossing 58. According to the step of embossing 58 the engraved platform now engraved is used for embossing a substrate through the placing of the engraved platform upon a substrate. According to one preferred embodiment of the present invention the engraved platform member is an engraved cylinder roller member. Embossing units such as two-station embossers, three-roll embossers, quad embossers manufactured by Industrial and Manufacturing Corporation from Pulaski, Wis., U.S.A. and other embossing units by other manufacturers can be used to implement some preferred embodiments of the present invention. According to other preferred embodiments of the present invention the step of embossing 58 includes the use of flat engraved platform as shown in FIGS. 7 and 8 below for the purpose of embossing the engraved hidden image onto the substrate. The nature of the embossing of substrate with protrusion from the engraved platform depends on the substrate's attributes especially the elastic attribute of the substrate. Each encounter between the substrate of any type and the engraved platform such as shown in FIGS. 5, 6, 7 and 8 requires a direct contact with adequate pressure for performing the embossing thus creating the hidden image below the surface of the substrate. Additionally, there are other factors relating to particular substrates that determine the embossing process such as stretching of substrate before, during and after an encounter with the engraved embossing platform member. Similarly, heating or cooling of substrate and engraved platform member can be performed before, during and after performing the embossing step 58. These factors as well as others determine the conditions used for a successful performance and lasting embossing of hidden images on substrate. According to one preferred embodiment of embossing of hidden images shown in FIG. 5 temperature is manipulated to ensure the embossing hidden images results. Thus, a substrate such as a polymer as poly vinyl chloride (PVC) needs to be wormed prior to encountering with engraved platform. Similarly, the engraved platform is also wormed prior to encountering with PVC substrate. After embossing is performed a cooling process of the embossed substrate is recommended. Naturally, the pre-heating as well as the after cooling process influence the production output of embossed hidden image on the production line. According to other preferred embodiments of the present invention substrates such as aluminum foil do not require pre heating before nor cooling after hidden images embossing. For example when the substrate to be embossed is aluminum foil, the engraved platform protrusions should be about 15 Microns high; the process of embossing is cold; the maximum pressure to be applied to the substrate during the embossing step is about 100 Bar. The speed to be used for embossing aluminum foil is about 100 meter per minute and the process can be performed at room temperature. Another non-limiting example of a material to be embossed is poly vinyl chloride (PVC) foil. In the process of embossing the PVC foil the protrusions on the engraved platform or plate should be about 20-25 Microns in length; the process of embossing PVC foil should be hot. The PVC foil should be preheated to about 60-80 Celsius (depending on the thickness of the foil) prior to embossing; the maximum pressure to be applied to the PVC foil during the embossing process should be about 50 bar and the maximum speed used by the embossing should not exceed about 20 meters per minute. The process of heating can be performed by a pressure roller or by an external preheating unit, such as a unit using ultra red heating. In general it is noted that the speed of embossing a substrate changes in accordance with the substrate's properties, thus cardboard can be embossed at speed ranging at the about 400 meter per minutes but heated PVC speed of embossing can be as low as 15 meters per minute. Other factors related to the speed of embossing are the type of cylinder or plate used and whether the process is hot or cold.

Persons engaged in the practice of embossing from cylinders or plates will appreciate the various factors to be taken into consideration when using a flat or round copper plated steel cylinder for embossing onto a substrate.

FIGS. 4A and 4B illustrate engraved cylinder roller members in accordance one preferred embodiment of the present invention. FIG. 4A presents an overview perspective of an engraved cylinder roller member 60 having a mirror image 62 comprised from protrusions that were engraved as described above in view of FIG. 3 above. FIG. 4B presents a frontal view of the same engraved cylinder roller member 60 shown in FIG. 4A. Image 62 is comprised from protrusions 64. The protrusions 64 can be in a triangle shape as shown in FIG. 4C. FIG. 4c presents one embodiment of a protrusion shape 66 engraved on cylinder roller member 60. FIGS. 4D and 4E present other shapes of protrusions according to other embodiments of the present invention. FIG. 4D shows a triangle protrusion shape 68 and FIG. 4E shows an inverted near full triangle shape 70. Each such shape 66, 68, 70 enables the creation of different optical frequency to be used in association with various corresponding decoders. The decoders to be used use a corresponding a frequency to enable the human eye to view the hidden image. The shape and dimensions used for a particular substrate are dictated by the attributes of the substrate used and the requirement to insert hidden images that remain invisible and can be viewed by a decoder adjusted to frequency of the embossed dots and lines. One important advantage provided by the present invention is that the hidden image is inserted on the substrate regardless of other processes relating to the substrate. Thus, the insertion of a hidden image into a printed matter substrate can be performed at any stage in relation to the printing of the substrate—before printing or after. Furthermore, the hidden image insertion process can be separated physically and positioned at a distant location from the printing location of the printed matter.

FIG. 5 illustrates an apparatus and method used to provide hidden images in accordance with a preferred embodiment of the present invention. FIG. 5 provides a side view of substrate 84, engraved cylinder roller member 80 and cylinder roller member 82. An engraved cylinder roller member 80 embosses substrate 84 with hidden image engraved on cylinder roller member 80. Arrow 90, arrow 92 and arrow 94 indicate, respectively, the movement direction of substrate and cylinder roller members 80 and 82. The engraved protrusions 86 on cylinder roller member 80 emboss on substrate 84 hidden image 88. Though the engraved cylinder roller member 80 includes protrusions of the type shown in FIG. 4C according to other embodiments other types of protrusions such shown in FIGS. 4D and 4E as well as others can be used. The dimensions of the recesses the comprise hidden image 88 within the embossed substrate 84 are subject to the protrusions 86 on the engraved cylinder roller member 80. However, the size of the recesses 88 can change subject to the elastic attribute of substrate 84 and the pressure applied by cylinder roller members 80, 82. Thus, according to one embodiment of the present invention an embossed hidden image's recesses within a PVC resembling material substrate will reduce in size after a twenty four hour waiting period after the embossing. Accordingly, the hidden images embossing process within a substrate with an elastic attribute will require an engraved cylinder roller member with large protrusions that will provide a lasting embossed hidden images within said substrate. According to the preferred embodiment as presented in FIG. 5, cylinder roller member 82 provides a support to embossed substrate 84 during the hidden image's embossing process. The process described above can be used as an anti counterfeiting measure of important documents and labels attached to products or on wrappers or directly on products or materials.

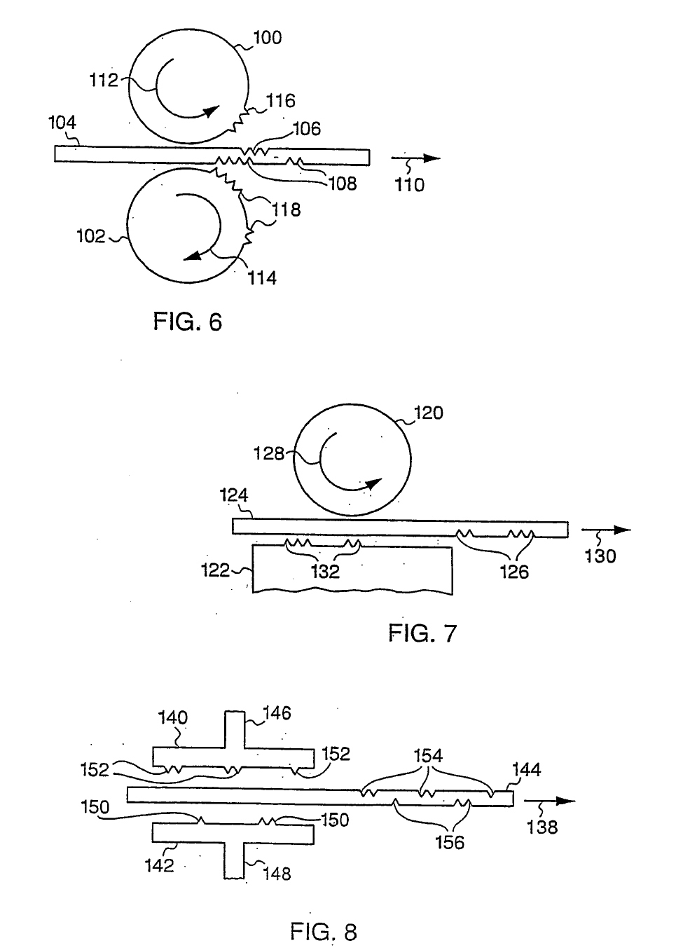

FIG. 6 presents an apparatus and method used to provide hidden images in accordance to a second preferred embodiment of the present invention. According to another preferred embodiment of the present invention embossing of hidden image's is performed from both sides of substrate 104. The apparatus for embossing according to the present preferred embodiment comprises engraved cylinder roller member 100 and engraved cylinder roller member 102 that emboss bidden image's from both sides of substrate 104. The engraved cylinder members shown are each an embossing platform member. Arrow 110 indicates the direction of movement of substrate 104. Arrow 112 indicates the direction of movement of engraved cylinder roller member 100 and arrow 114 indicates the direction of movement of engraved cylinder roller member 102. According to one embodiment the embossed recesses can be viewed each side separately. Thus, embossed hidden image 106 created by protrusions 116 can be viewed by a decoder only from one side and embossed hidden image's 108 created by protrusions 118 can be viewed only from one side. This embodiment can be used for bank notes, documents and the like. According to another embodiment embossed hidden image's 108 performed by protrusions 118 can be viewed on the other side of substrate 104 as well. Similarly, embossed hidden image's 106 performed by protrusion 116 can be viewed at both sides of substrate 104. According to the preferred embodiment the hidden image's that can be viewed from both sides have a different frequency of dots and lines that comprise the hidden images thus, viewing hidden images performed at different sides of substrate 104 requires different decoders. Consequently, providing each side of substrate 104 with an identification of one or more hidden images. Suc can be for example employee identification tag described above allowing a number of security levels to be embedded in the tag or one or more hidden image applied into a substrate for promotional purposes. Another example is applying the hidden image to a substrate such as paper to prevent counterfeiting of documents.

FIG. 7 illustrates another preferred embodiment of the present invention wherein hidden images 126 are inserted within substrate 124. According to the preferred embodiment plate embossing member 122 includes protrusions 132 that comprise an image. Substrate 124 having a direction of movement as indicated by arrow 130 is embossed by protrusions 132. Substrate 124 can be compelled by cylinder roller 120 having direction of movement indicated by arrow 128. Recesses 126 received from the embossing comprised the hidden image within substrate 124. According to the preferred embodiment plate embossing member 122 with protrusions 132 is static.

FIG. 8 presents another preferred embodiment according to the present invention. According to this preferred embodiment substrate 144 is embossed from both sides by plate embossing member 140 with protrusions 152 and by plate embossing member 142 with protrusions 150. Protrusions 152 comprise a mirror-hidden image engraved on embossing member 140. An embossed hidden image is embossed on the upper face substrate 154 and is represented as recesses 154 or 156. Similarly, protrusions 150 on plate embossing member 142 can emboss a hidden image comprised from recesses 156 on the lower face of substrate 144. According to the preferred embodiment the direction of movement of substrate 144 is indicated by arrow 158. Plate embossing member 140 is connected to handle 146 and plate embossing member 142 is connected to handle 148. Handles 146 and 148 are connected to hydraulic mechanism electrically operated and computer controlled to effectively emboss both the upper and lower face of substrate 144. According to this method and apparatus a substrate may include an embossed hidden image on either face of substrate 144 enabling a variety of uses for the substrate. Thus, for example, substrate 144 can be used for documents that can be authenticated from either side as original. In addition, each embossed hidden image can have a different optical frequency thus enabling the use of more than one decoder to examine the same product in association with which substrate 144 is used. In one example, a CD Rom can be embossed with different hidden images on the side opposite the side having digital information embedded on making it difficult for counterfeiters to unlawfully copy the original.

The person skilled in the art will appreciate that what has been shown is not limited to the description above. Many modifications and other embodiments of the invention will be appreciated by those skilled in the art to which this invention pertains. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

It will be appreciated by persons skilled in the art that the present invention is not limited to what has been particularly shown and described hereinabove. Rather the scope of the present invention is defined only by the claims, which follow.

What is claimed is:

1. A method for providing a hidden image within a substrate the method comprising embossing recesses on the substrate, the recesses form an at least one hidden image, whereby the at least one hidden image can be viewed with the use of at least one decoder.

2. The method of claim 1 further comprising the step of providing an image to be converted into the digital information to be used for engraving protrusions onto an embossing platform member.

3. The method of claim 1 further comprising the step of engraving protrusions associated with digital information representing the at least one hidden image onto an embossing platform member.

4. The method of claim 1 further comprising the step of determining from the digital information the location of each recess to be engraved unto an embossing platform member representing the at least one hidden image to be embossed on the substrate.

5. The method of claim 2 further comprising the step of converting the image provided into digital information comprising the locations on an embossing platform member for creating protrusions, the conversion comprises selecting the features of the image located along predetermined lines or wave like lines representing the optical frequency to be used in the creation of the hidden image or the reverse optical frequency to be used in the creation of a decoder.

6. The method of claim 1 wherein the recesses are embossed on both sides of the substrate.

7. The method of claim 1 wherein the step of embossing comprises an at least one embossing platform member applying pressure on the substrate for creating the recesses thus forming the at least one hidden image.

8. The method of claim 1 wherein the hidden image comprises text or at least one animated figure or a combination thereof.

9. The method of claim 1 wherein the decoder is a flexible material embossed with an at least one set of lines for revealing the at least one hidden image formed by the recesses on the substrate.

10. The method of claim 1 wherein the substrate is a material having sufficient flexibility to be used in the process of embossing.

11. The method of claim 1 wherein the substrate any one of the following substrates: polymeric sheet, fabric, processed wood, metal sheet, or a composition of thereof.

12. The method of claim 1 wherein the recesses are about 1-50 microns in depth.

13. The method of claim 1 wherein the recesses are about 1-30 microns in diameter.

14. The method of claim 1 wherein the at least one hidden image is used for determining whether the substrate is original or approved.

15. The method of claim 1 wherein the at least one hidden image is used for revealing a message or an image.

16. The method of claim 1 wherein the at least one hidden image is used for determining the substrate's authenticity.

17. The method of claim 1 wherein the decoder is attached to the substrate.

18. The method of claim 3 wherein the embossing platform member comprise a steel or metal core having a thin plated layer of copper and chrome.

19. The method of claim 3 wherein the embossing platform member is in the form of a cylinder or a sleeve to be put on the cylinder or a plate.

20. The method of claim 3 wherein the step of engraving comprises engraving on the surface of the embossing platform member of a mirror hidden image to be embossed on the substrate.

21. The method of claim 3 wherein the step of engraving comprises providing protrusions unto the embossing platform member.

22. The method of claim 21 wherein the protrusions represent a mirror image of the optical frequency used in to emboss the at least one hidden image.

23. The method of claim 5 wherein the number of lines to be used in encoding of the at least one hidden image is about 1,000 lines per inch.

24. The method of claim 11 wherein the polymeric sheet includes poly vinyl chloride or nylon or cellophane a composition thereof.

25. A substrate comprising an embossed hidden image, the hidden image is embossed onto a substrate, the hidden image is created in association with an optical frequency not visible to the naked eye, the hidden image cannot be seen without the use of a decoder having a reverse optical frequency.

26. The substrate of claim 25 wherein the substrate is a material having sufficient flexibility to be used in the process of embossing.

27. The substrate of claim 25 wherein the substrate is made of a polymeric sheet or metal sheet or processed wood or processed leather or a composite material.

28. The substrate of claim 25 wherein the embossed hidden image comprises recesses in a depth of about 1-50 Microns.

29. The substrate of claim 25 wherein the embossed hidden image comprises recesses having a diameter of about 1-30 Microns at the upper surface of substrate.

30. The substrate of claim 25 wherein the hidden image comprises text or at least one animated figure or a combination thereof.

31. The substrate of claim 25 wherein the substrate is any one of the following substrates: polymer, fabric, wood, metal, or a composition thereof.

32. The substrate of claim 25 wherein the hidden image is used for determining whether the substrate is original or approved.

33. The substrate of claim 25 wherein the hidden image is used for revealing a message or an image.

34. The substrate of claim 25 wherein the hidden image is used for determining the substrate's authenticity.

35. The substrate of claim 25 further comprising a decoder attached thereto for revealing the hidden image.

36. A substrate comprising a decoder for viewing an embossed hidden image, the decoder comprises embossed or printed lines having a reverse optical frequency to the optical frequency used to create the hidden image embossed onto a substrate.

37. The substrate of claim 36 wherein the decoder is made of a polymer material.

38. The substrate of claim 36 wherein the decoder is made of a clear material allowing the placement of the decoder upon the substrate containing the hidden image so that when the decoder is placed in a predetermined angle the hidden image is revealed through the decoder.

39. The substrate of claim 36 further comprising a substrate comprising an embossed hidden image.
